(19) United States
(12) Patent Application Publication
(10) Pub. No.: US 2001/0031458 A1
(43) Pub. Date: Oct. 18, 2001

(54) System and method for assisting high school students with college applications

(76) Inventor: Jacob Barnhart Schramm, Washington, DC (US)

Correspondence Address: JACOB B. SCHRAMM, COLLEGE SUMMIT, P.O. BOX 9966, WASHINGTON, DC, 20016, US

(21) Appl. No.: 09/845,307

(22) Filed: May 1, 2001

Related U.S. Application Data
(60) Provisional application No. 60/200,760, filed on May 1, 2000.

(51) Int. Cl. G09B 3/00

(52) U.S. Cl. 434/350

(57) ABSTRACT

A system for assisting high school students in applying for college, comprising an intensive residential workshop for students, college mentoring assistance to high schools, assistance to colleges in the form of an expanded pool of talented applicants, an alumni training program, and a computer program and database for implementing various aspects of the system.

This application is based on Provisional Application Ser. No. 60/200760 filed May 1, 2000, to which priority under 35 U.S.C. §119(e) is claimed. The specification of Ser. No. 60/200760 is incorporated herein by reference.

### BACKGROUND—FIELD OF INVENTION

This invention relates to the field of college access for high school students.

### BACKGROUND—DISCUSSION OF RELEVANT ART

In the current art, programs and institutions typically focus on either individualized college preparation for paying students, or generalized college awareness for non-paying, low-income students.

Individualized preparation for paying students is a booming business. Parents recognize the great advantage that personalized counseling can have for their children, and pay top dollar to give them a leg up. Moreover, generalized college counseling exists in varying degrees in all public high schools, but as the income level of a community decreases, the ratio of students to counselors generally increases, and the quality of college counseling proportionally goes down.

To the extent anyone has created a system of individualized college preparation for low-income or minority students, such efforts generally address only a subset of either group, usually focusing on the students with high grades or high standardized test scores. This leaves a large portion of low-income, academically mid-tier students with insufficient support and resources to advance to higher education. And objective measures confirm this chasm: according to the U.S. Census, only 46% of high school graduates from families earning $40,000 or less annually enroll in college the fall after graduation. For families earning more, the college enrollment rate of high school graduates is approximately 75%.

As anyone who has applied to college knows, the transition from high school to higher education is complicated, detail-oriented, and not intuitive. The process takes at least one year of planning; it requires students to register for, prepare for, take, and submit scores from at least one standardized test; it involves detailed and confusing financial aid forms (assuming one can even determine potential sources of financial aid); and it requires knowledge of and discretion about an enormous range of types of higher education institutions. It also requires an understanding—which is almost by definition obscured from a 17-year-old's view—of which qualities and characteristics college admissions offices are looking for. For students with adequate support from (and experience within) their families, schools, and communities, the transition is manageable, perhaps even nurturing. But for low-income students, most of whose parents have not gone to college, and most of whose school guidance counselors are overwhelmed by bloated caseloads, the regular college transition hurdles are often insurmountable. Indeed, these students' hurdles are too often compounded by poverty, dire family responsibilities, and an absence of long-term preparation for the challenges of higher education.

There is thus a need for a system for individualized college preparation assistance that provides intensive as well as continuing assistance to students who would otherwise have difficulty completing and following through on college entrance applications, including but not limited to low income, academically mid-tier students. The invention addresses that need by providing a system that can include 1) helping students recognize and present their true strengths; 2) helping schools reform their college guidance systems; 3) helping colleges constructively expand their applicant pools; 4) training student alumni to nurture and expand the system; and 5) organizing the entire effort into a database that supports the system on a large scale into the future.

### OBJECTS AND SUMMARY OF THE INVENTION

The present invention provides an effective, systemic way to help students, schools, and colleges accomplish their shared goal: to match as many students as possible with the colleges where they will thrive. The following objects are achieved by some but not necessarily all embodiments of the invention. The scope of the invention is as set forth in the appended claims.

One object of the present invention is to provide high school students with a means of recognizing and presenting their truest strengths to colleges.

Another object of the present invention is to provide high school students and their parents with sufficient information about higher education opportunities and financial aid so that they can make informed, successful decisions about students' college options.

Another object of the present invention is to increase students' chances of enrolling by providing colleges and universities with timely, comprehensive, and useful “Preview Portfolios” on each student who matches their admissions criteria.

Another object of the present invention is to assist high schools in reforming their overall college guidance systems, so that overburdened college counselors can help additional, college-capable students pursue higher education.

Another object of the present invention is to assist colleges in their methods of identifying, recruiting, and retaining high school students.

Another object of the present invention is to train student alumni in several discrete skills to help other, younger students access higher education opportunities as well.

Another object of the present invention is to create and maintain a comprehensive, user-friendly database that enables the management of the overall invention, including tracking and appropriately linking all the students, schools, colleges, and community volunteers who participate in these efforts and, where appropriate, transferring data and documents easily among them.

Additional objects and advantages of the invention are set forth in part in the description that follows, and in part are obvious from the description, or may be learned by practice of the invention.

### BRIEF DESCRIPTION OF THE DRAWINGS

The accompanying drawings, which are incorporated in and constitute a part of this specification, illustrate particular embodiments of the invention, and together with the description, serve to explain the principles of various embodiments of the invention.

FIG. 1 is a diagram of the multi-day workshop of an embodiment of the invention, describing its ingredients and contributors, its activities, and its resulting work product.

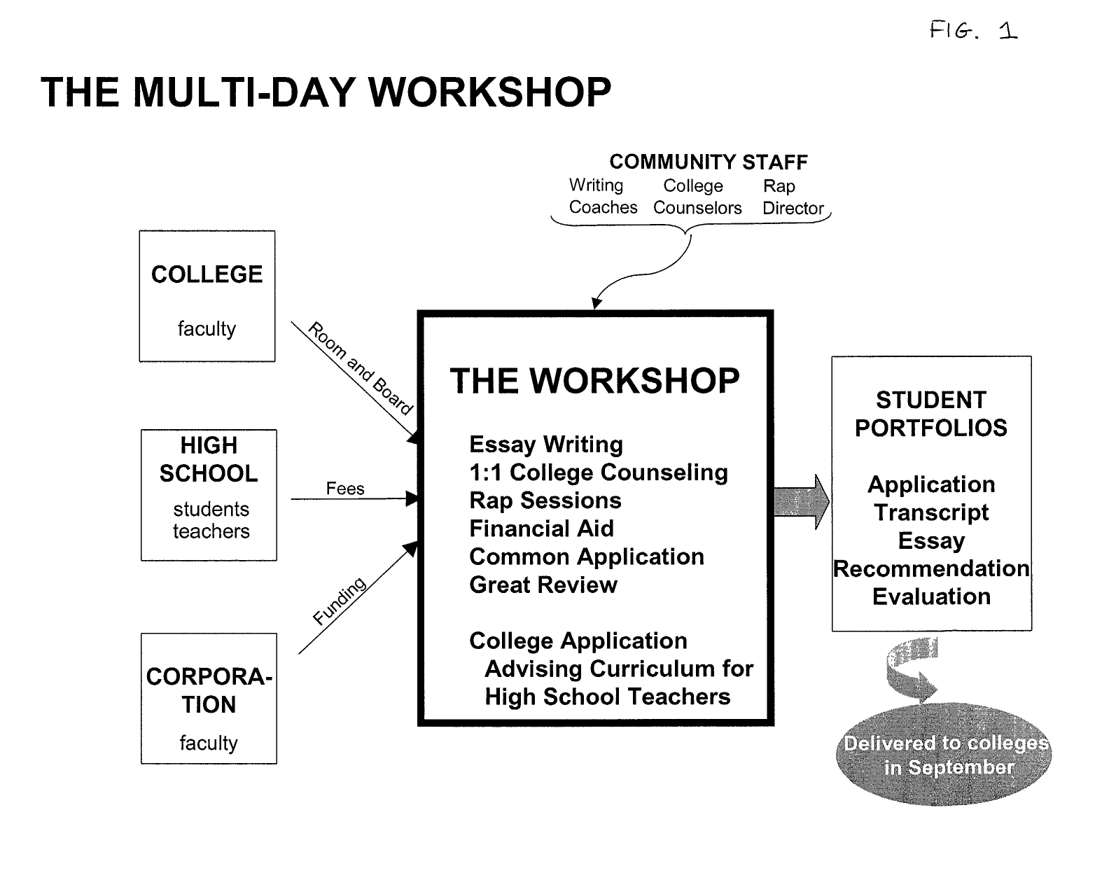

FIG. 2 is a depiction of the overall system of an embodiment of the invention, showing what value each participant receives.

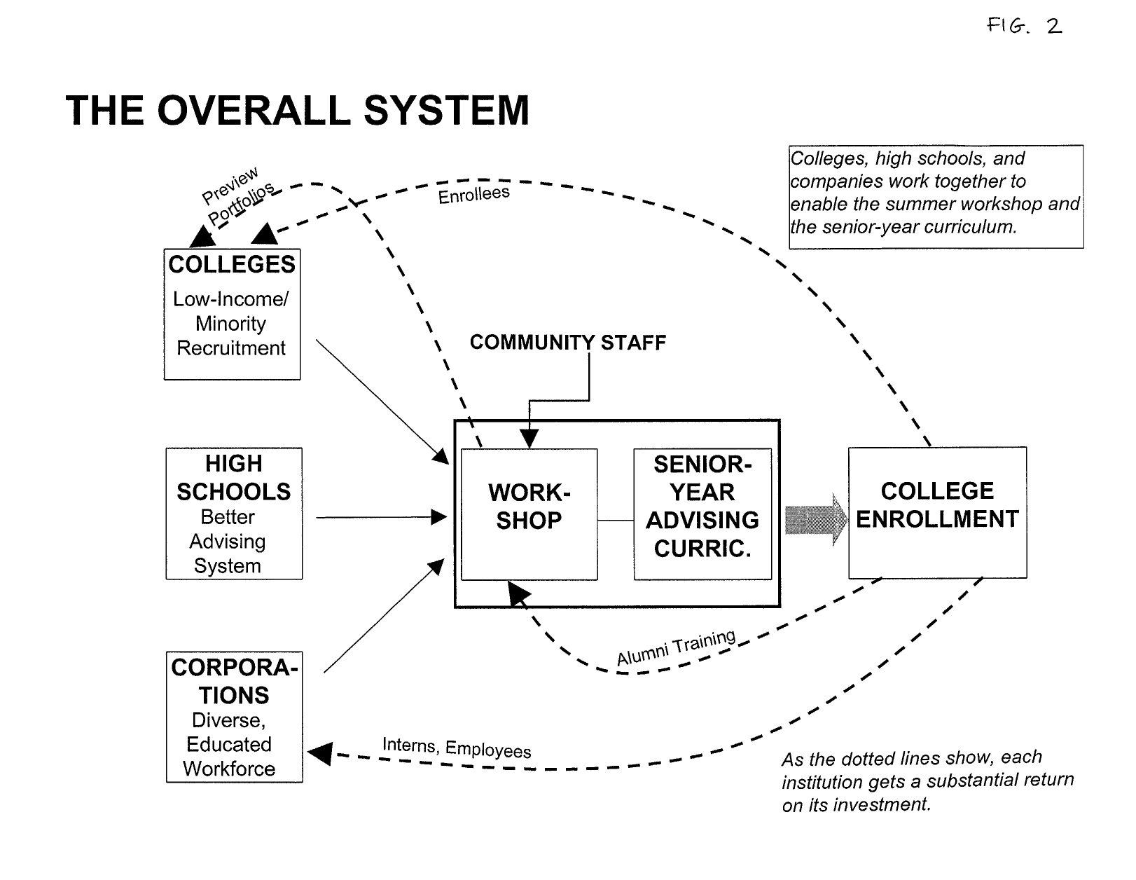

FIG. 3 is a timeline of the program's assistance to colleges with regard to Preview Portfolios.

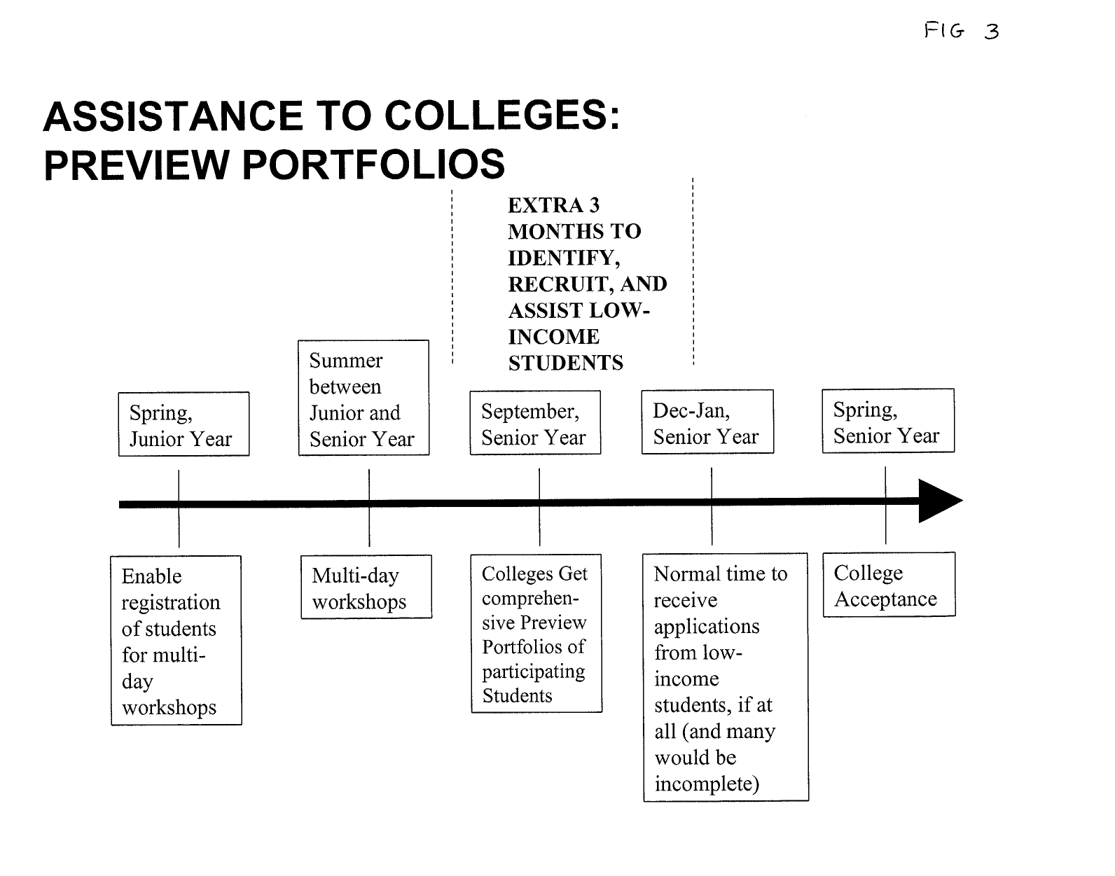

FIG. 4 is a diagram of the program's assistance to colleges with regard to structured meetings about recruitment strategies.

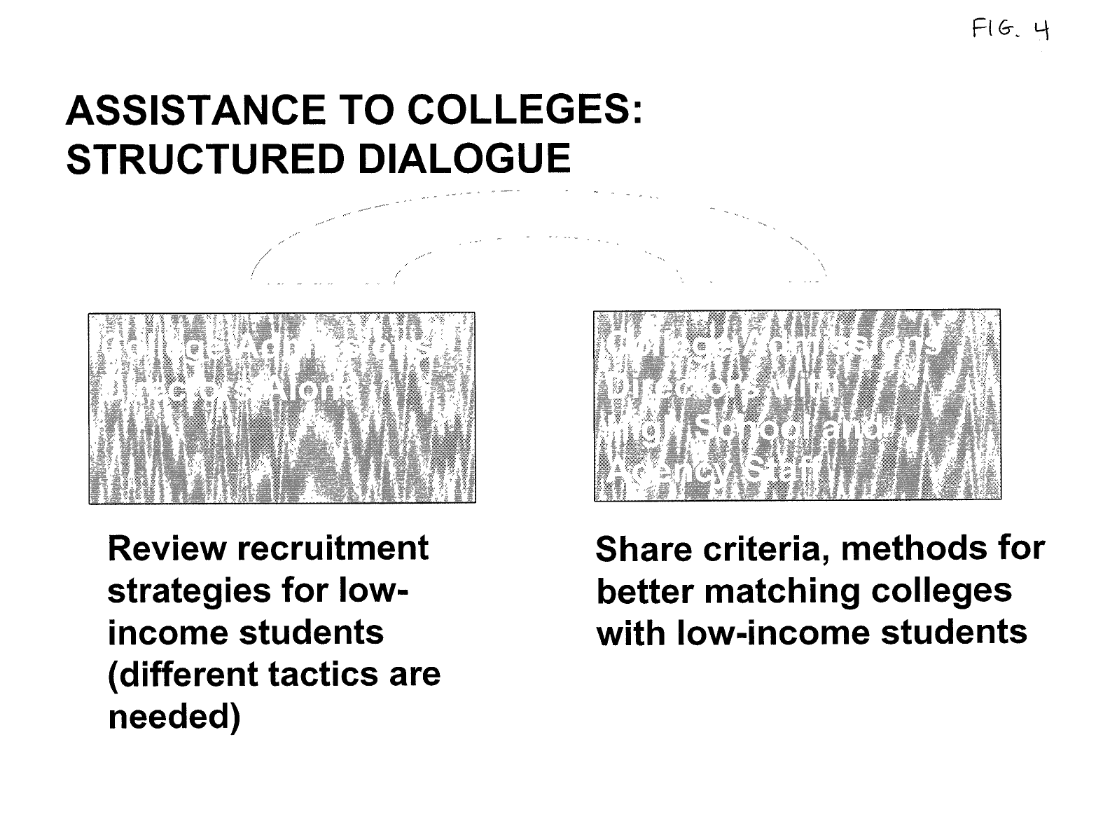

FIG. 5 describes the alumni training and leadership development opportunities available through an embodiment of this invention.

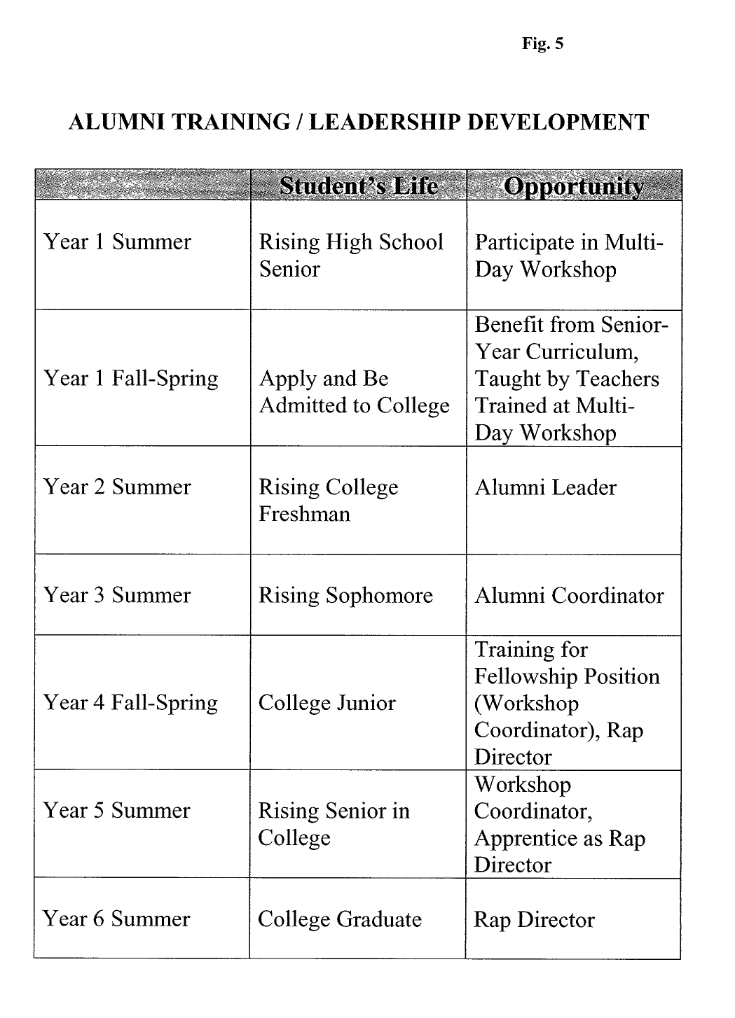

FIG. 6 describes the database that permits an embodiment of the invention to function, forming and managing all elements of the workshop as well as the senior-year curriculum, and also tracking and connecting the people, institutions, and documents that participate in, support, and/or compose the program.

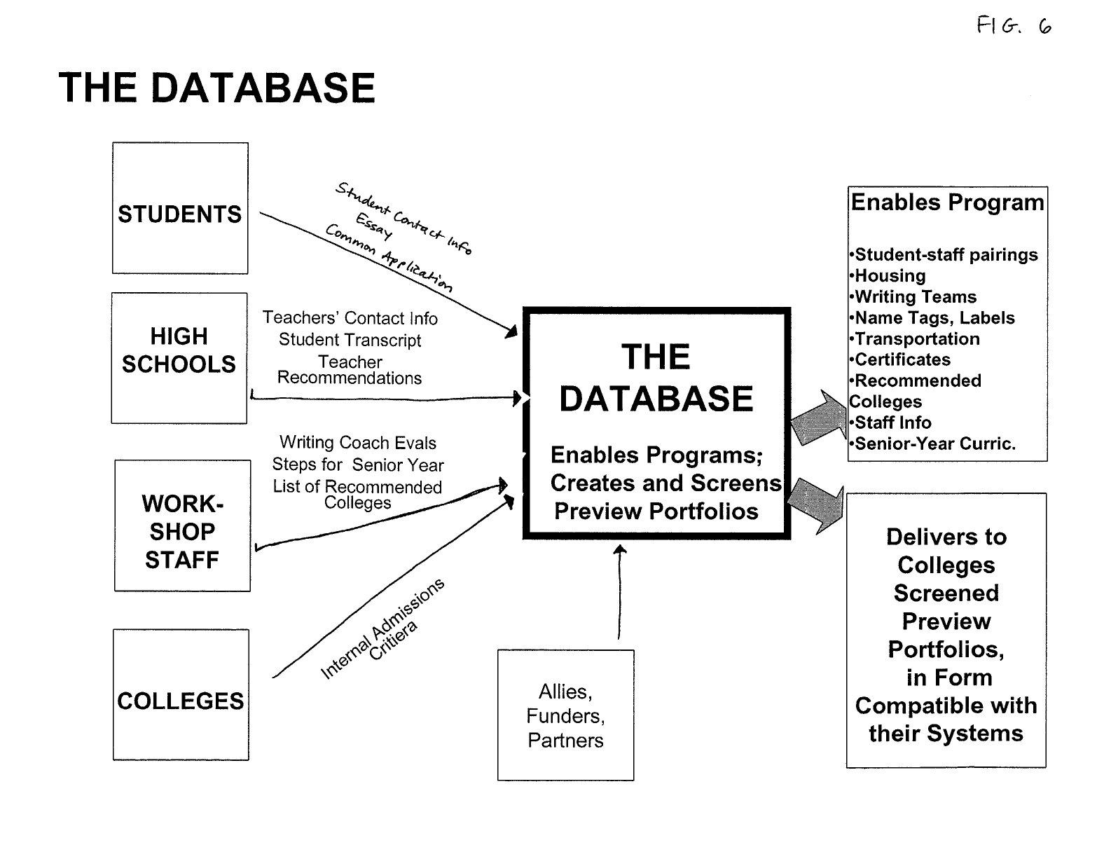

### DEFINITIONS

“Low-Income” for purposes of this invention is defined by the Federal poverty guidelines established by the U.S. Department of Education's TRIO programs. Specifically, two-thirds of the participants selected by their schools or youth agencies must come from households at or under 150% of the federal poverty line, and the other third must be “economically disadvantaged,” according to the judgment of the school or youth agency.

An “academically mid-tier” student is defined as one who has more college promise than one's grades and standardized test scores would suggest. Most such students have cumulative grade point averages in the B-D range and middle-to-low range standardized test scores.

“Workshop” is defined as a multi-day, structured event in which students work primarily on processes and materials related to their college applications.

“Writing Coach” is defined as a person assigned to help a student or students with the college essay or personal statement during the workshop.

“College Application Advisor” (“Advisor”) is defined as a teacher, youth worker, corporate volunteer, community leader, or other adult assigned to or committed to helping one or more students manage their college application path(s) during senior year of high school.

“College Counselor” is defined as a person with professional experience and/or training in the college admissions process.

“Rap Director” is defined as a person with experience and/or training in the process of leading students through explorations of their personal goals and obstacles, as such explorations affect college enrollment.

“Alumni” are defined as persons who have completed the program described in this invention, including the multi-day workshop and the senior-year curriculum. They are frequently enrolled in or graduated from college at the time they participate in the role described in the specifications and claims herein.

“Alumnus” is defined as the singular of “alumni, whether male (“alumnus”) or female (“alumna”).

A “Common Application” is a college application form that is not specific to any particular institution of higher education, but rather is accepted by multiple colleges and universities in the United States.

A “Preview Portfolio” is defined as a set of student-related materials usable by college and university admissions personnel to assess the whole student. The materials generally include a personal essay, transcript, common application, teacher or youth worker recommendation, and Writing Coach evaluation.

“His” is defined to mean “his or her.”

“He” is defined to mean “he or she.”

Description and Operation—Main Embodiment

One embodiment of the invention comprises a five-part system for assisting a low income, academically mid-tier student with the college application process, but the invention also comprises embodiments using only some of the five parts described herein, and also can be applied to assist students who do not meet the definition of low income, academically mid-tier. A description and operation of each of the parts is provided below, in the context of an embodiment directed to assisting low income, academically mid-tier students.

1. The Workshop

The multi-day residential workshop helps low-income, academically mid-tier students identify and present their truest strengths to colleges. The workshop generally occurs in the summer between the students' junior and senior years in high school, and takes place in a residential setting, generally a college campus. In a typical embodiment, approximately 30-50 students attend each workshop, supervised by approximately 15-30 “faculty,” including a Workshop Director, one to three Workshop Coordinators, five to ten Writing Coaches, five to ten teachers or youth workers (who are being trained as College Application Advisors), one to five college counselors, and several alumni leaders. When the workshop is held on a college campus, the college typically provides room and board for the workshop, and the use of classrooms and a computer lab. It will be recognized that the workshop can be held at other times, that the attendance of the workshop can be substantially more or less than that of the typical embodiment discussed above, and that the invention can be practiced even without all categories of non-student participants.

In one embodiment, the workshop comprises a writing team curriculum, college counseling, the “Great Review,” the “Rap Session,” financial aid, computer-based applications, and “College Application Advisor” training, although no single one of these parts is an essential component of the invention. Each of these seven components of the workshop is discussed below.

A. Writing Team Curriculum. Students compose personal essays during at least six hours of small group writing sessions in the residential, multi-day events, facilitated by a Writing Coach trained in a writing curriculum designed to help students prepare their college essays. The students' personal essays complement certain numerical indicators of potential such as SAT scores and grades and often show, e.g., a student's growth, courage, humor, or creativity. With this writing team method, the Writing Coach leads the students through deliberate steps ranging from unrestricted free writing to the construction of a thesis statement and argument. Specifically, the students start with 5-15 minutes of writing whatever is on their minds, followed by a process of “gold-mining,” wherein the other students, guided by the Writing Coach, listen for the key phrases, words, and ideas. Then the Writing Coach urges students to free-write again, expanding upon one of the phrases or ideas in their first effort. A second “gold-mining” session is held. Over the remaining hours of the writing sessions, the Writing Coach and the other students assist each student in the crafting of a personal message. Grammar review and instruction is generally the last part of the essay creation process.

B. College Counseling. Through private meetings, generally lasting one hour, with professional college counselors, and a structured review of each student's materials by the entire workshop staff, participants are guided through the process of selecting appropriate colleges for application. The approach encourages students to prepare to apply to a range of types of colleges. This invention not only helps students identify campuses that meet their academic, financial, and social needs, but also takes into account the changes in personal circumstances that more often confront low-income students. In addition to recommending colleges, counselors also identify key academic, extracurricular, and pre-college steps that students should take during senior year.

C. The “Great Review.” In the evenings of the workshop, a diverse team of educators, including the college counselors, Writing Coaches, and teachers or youth workers from the students' schools or youth agencies, review every participant's past and present performance to recommend colleges that best suit the student's needs. Specifically, each student is reviewed by the entire faculty once for approximately six minutes, such that by the end of the workshop, each student's “case” has gotten focused, individualized attention from adults in three different roles. The professional college counselors, including at least one local and one national counselor, bring to bear a breadth of experience. The student's writing Coach makes recommendations based on how the students handles realistic college challenges over the course of the four-day workshop. The teachers or youth worker who brought the student brings the perspective of the student's roles in his home or school setting. These diverse perspectives give rise to refined recommendations as to what type of college or university might best serve each student's needs.

D. The “Rap Session.” In daily group sessions involving discussions and role-play exercises, led by “Rap Directors,” students explore their dreams and challenges concerning college. For example, students learn to acknowledge and examine the key life transition they are entering: from dependence to independence, from childhood to adulthood. With the guidance of the skilled Rap Director, the students probe choices and possibilities, preparing themselves to make healthy choices about adulthood, and to probe for opportunities in life beyond those that are immediately or obviously presented. In the course of the group strategy sessions and challenge games, the students also often learn to take responsibility for their goals publicly, so that their peers and teachers can help hold them accountable for their commitments.

E. Financial Aid. Students review basic financial aid options and complete a model Federal financial aid form (FAFSA). They also perform guided Internet scholarship searches.

F. Computer-Based Applications. Students complete a computerized common application, which documents all their relevant personal information and is accepted by more than 100 colleges and universities nationwide. Students can also apply to colleges outside that network using their computerized application as a model.

G. “College Application Advisor” Training. Teachers and youth workers who accompany the students to the workshop and commit to implement the senior-year curriculum are provided a comprehensive, four-part training program during the multi-day workshop. 1) They are instructed in the Writing Team method, so that during senior year they may assist their other students, who did not attend the workshop, in crafting their college essays. In a preferred embodiment, the Writing Team method instruction is provided by the College Summit Writing Coach Coordinator Handbook (copyright 1995) and implemented using the College Summit Advisor Handbook (copyright 2001) (available at College Summit, 4420 Connecticut Avenue, NW, Washington, D.C. 20008). 2) Teachers and youth workers are also instructed in the art of Recommendation Writing, so that they may themselves be better advocates for their students in the college admissions process. In a preferred embodiment, the Recommendation Writing method instruction is provided by the College Summit Writing Coach Coordinator Handbook (copyright 1995) and implemented using the College Summit Advisor Handbook (copyright 2001) (available at College Summit, 4420 Connecticut Avenue, NW, Washington, D.C. 20008). 3) They are taught, in a third module, how to guide students through the financial aid forms and processes. In a preferred embodiment, the Financial Aid Form instruction is provided by the College Summit Financial Aid Officer Handbook (copyright 1995) and implemented using the College Summit Advisor Handbook (copyright 2001) (available at College Summit, 4420 Connecticut Avenue, NW, Washington, D.C. 20008). 4) And fourth, the Advisors are instructed in a Senior-Year Curriculum, including how to use On-Line Tools, to complete the college application process. In a preferred embodiment, this instruction is provided by the College Summit Workshop Director Handbook (copyright 1995) and implemented with the College Summit Advisor Handbook (copyright 2001) (available at College Summit, 4420 Connecticut Avenue, NW, Washington, D.C. 20008). This curriculum teaches the advisors to guide students through the remainder of the college application process, including such skills as acquiring application fee waivers, interpreting financial aid offers, working with ambivalent families, and other pertinent skills.

2. Assistance to High Schools: “College Application Advisors”

The invention can also comprise a component that helps schools reform their systems of college advising. It recognizes that whereas college guidance is often thought of as a one-role task, performed by a College Guidance Counselor, that role is in fact supplemented in successful college-going communities by a student “manager,” usually a college-experienced parent. The “manager” helps keep the student on his or her individual track to college, ensuring that all of the large and small tasks of the application are completed in a timely fashion. For an embodiment implemented in schools in low-income school districts, this aspect of the invention trains a new cadre of people to play that supplementary, managerial role—usually in lieu of, but occasionally in addition to, college-experienced parents.

This part of the invention involves an assessment of current school advising structures, and assistance incorporating a system of weekly College Application Advising sessions into the students' senior year. The curriculum for these weekly sessions includes the modules taught to the Advisors at the workshop, including essay writing (for students who did not attend the workshop), recommendation writing, financial aid forms, and other information related to the college application process. In one embodiment, this aspect of the invention is supported by a handbook that provides a step-by-step guide to assisting a student through the application process, and helps the teachers or advisors contact admissions and financial aid offices on behalf of the students, facilitate parent involvement, and interpret financial aid offers. An example of such a handbook is the College Summit Advisor Handbook, mentioned above. In one embodiment, College Application Advisors also use periodically published guides, such as College Summit's bi-weekly guides (College Summit Follow-Up Guides, copyright 1995, available at College Summit, 4420 Connecticut Avenue, NW, Washington D.C., 20008), which are distributed to every participating youth agency and school to remind them of the critical college-path tasks in those weeks. Such tasks may include, for example, registering for the SAT or ACT, obtaining the FAFSA form, etc. The senior-year curriculum runs from the close of the multi-day workshop until the students have accepted admissions and financial aid packages in the spring of their senior year.

3. Assistance to Colleges: Expanding the Pool of Talented Applicants

The invention can also comprise a component that involves assistance to colleges and universities in identifying and recruiting those students who, while they may not shine on standardized tests, are likely to succeed in college. In the current art, there are large gaps in colleges' and universities' ability to identify low-income students' strengths beyond those that might be evident through test scores.

This component has two elements.

A. Training to Expand College Admission Criteria. This aspect of the invention helps college admissions directors expand the criteria on which to judge students. The program facilitates two types of structured meetings or engagements: (1) a meeting in which regional college admissions directors jointly review their recruitment strategies for low-income youth; and (2) a meeting in which college admissions directors join with participating high school and agency staff to share information about college admission criteria and hear suggestions for better methods to evaluate low-income students for admission. Such meetings are conducted in the spring and/or fall.

B. Resource for Recruiting Diverse, Low-Income College Applicants. In one embodiment, following the workshop season, the central office sends each college that has hosted a workshop a Preview Portfolio on every student who matches that college's admissions criteria. Preferably, this step occurs in the September following the workshop, but it can occur as early as August, and as late as December. Each portfolio generally includes the student's essay, the Writing Coach's evaluation, the student's high school transcript, the student's completed common application, and a teacher recommendation. These Preview Portfolios allow colleges and universities to see more students, more comprehensively, and earlier. This service further permits colleges to pinpoint steps that borderline “admits”, such as certain low-income, academically mid-tier applicants, must take in the fall to become attractive candidates in the spring.

Moreover, colleges can identify grant opportunities for students early, while such funds are still available.

4. Alumni Training Program—Creating “Rap Directors”

The invention can also comprise a program for training several promising alumni per year to participate in a separate, multi-day training (8-24 days) in leadership development and community engagement. One goal of this training is to prepare alumni to serve on workshop faculty as Rap Directors at program workshops. As described above, Rap Directors facilitate discussions with the student participants around their personal obstacles, and help them identify personal goals as well as strategies to achieve them.

The training itself takes place in several parts. In one embodiment, selected program alumni who have completed a certain amount of college, preferably at least three years, are invited first to undergo an apprenticeship in one of the multi-day workshops, wherein each trainee observes all the Rap Sessions led by an experienced Rap Director. Following the workshop, they undergo an intensive program themselves, led by the Rap Director, in which they explore their own personal obstacles in the same way they will challenge their students to do, once they are directing Rap Sessions. At the end of that intensive program, the trainees attend another multi-day workshop, at which time they conduct the Rap Sessions themselves, as under the careful tutelage of the trained Rap Director. Following that trial directorship, the trainees complete additional follow-up sessions during the year with the trained Rap Director, and by the following summer, the alumni are themselves ready to serve in the critical role of workshop Rap Director.

5. The Database

The invention can also comprise an electronic database and associated computer program, maintained by the organizational center, that makes the overall invention work. The computer program takes in and stores in the database key contact information about every participant in the program, including, e.g., students, high schools, colleges, youth agencies, workshop staff, volunteers, and funders. It then permits the organization center to produce all the documents that make the multi-day workshops feasible, including the student-staff pairings, housing assignments, transportation arrangements, name tags and labels, Writing Teams, students' recommended colleges, Preview Portfolios (which are delivered to the colleges in September following the workshop season), and the college assignments.

In addition, the computer program allows each of the constituencies or parties that participates in the program in any way to access the data in the database that is appropriate to his or her role. For example, following a workshop, a student may access (and edit) her own essay and common application. She can also access the contact information for the other students at her workshop, and for her Writing Coach. She is blocked, however, from accessing the essays or transcripts of other students, or information about staff not assigned to her, or information concerning, for example, overall staff duties, the central office's relations with college hosts, or program funding. Similarly, a college counselor or teacher who signs up for a workshop can access the database in advance to learn about pre-workshop tasks, student and colleague information, and driving directions, and during the workshop can file student reports or teacher recommendations directly into the database. After the workshop, teachers can find the senior-year curriculum directly on the web-enabled system. Only central office staff, however, who organize and implement the entire program, can access the entire database. The computer program and database sustain and strengthen the community created through participation in the overall program.

Finally, the computer program facilitates the rapid, electronic dissemination of the students' screened portfolios to the colleges where they have been recommended to apply. Once a student portfolio is complete—including the essay, transcript, common application, teacher recommendation, and Writing Coach evaluation—it is grouped by the computer program in the database with other matched portfolios and delivered electronically to the recommended college or university partner, in a form compatible with that institution's candidate database. For example, at the end of a workshop season, if 1,000 students participate in workshops and prepare their college application materials, perhaps 100 of them will have been “matched” or recommended to one of the colleges that hosted a workshop. The computer program sorts and tracks each of the components of the portfolios; groups them, once they are complete, with the other portfolios recommended to that institution; and delivers them electronically to that college or university in a format that the college's admission office can use. The programming steps needed to make a computer program with the above-described functionality are well within the abilities of a person with ordinary skill in the art of computer programming.

### Description and Operation—Alternative Embodiments

It will be readily apparent that the invention described herein is not limited to the specific embodiments described above, and that the scope of the invention is limited only by the appended claims. Other embodiments of the invention could add discrete elements to the same core model; e.g., lengthen the program, add academic coursework and/or standardized test preparation, etc. Parts of the system could be used in a variety of forms.

Institutions or communities could use the multi-day workshop, e.g., toward a slightly different end; for example, scholarship funds could use it to streamline the identification of students most likely to succeed with their financial assistance. Fellowship or internship programs could use the workshop to identify and track those young people most likely to thrive with those opportunities. Indeed, colleges or universities could use both the workshop and advising model for admissions decisions directly; or other organizations looking to recruit young high school graduates, such as community service programs, could use the workshop to screen, review, and place applicants; and use the alumni training portion and the centralized database to sustain their organizations.

Finally, employers or headhunters could use this model to provide job search or job matching services for young people nationwide. Indeed, any organization looking to review large pools of prospective applicants could use the intensive workshop model to better evaluate the candidates, and use the database and network system to both facilitate the workshop and sustain relationships among or the community of the various partners or constituencies.

What is claimed is:

1. A method for assisting a high school student with the college application process, comprising:
providing a multi-day workshop for a plurality of high school students;
associating a writing coach with a student;
receiving writing coach input from said writing coach regarding said student; and
using said writing coach input in a submission to a college associated with said student.

2. The method of claim 1, further comprising:
identifying an alumnus of a program for assisting high school students with the college application process;
providing leadership training to said alumnus; and
promoting said alumnus to a position wherein said alumnus participates in said multi-day workshop, wherein said alumnus, in the course of said workshop, facilitates discussions with said students concerning their goals and experiences.

3. The method of claim 2, wherein the training given to said alumnus comprises an apprenticeship with an individual who has previously led discussions with students concerning their goals and experiences.

4. The method of claim 2, further comprising providing said alumnus a forum for sharing his experiences with other alumni.

5. The method for assisting a high school student with the college application process of claim 1, further comprising:
providing a forum for said student to share his experiences and goals with an audience of fellow students.

6. The method for assisting a high school student with the college application process of claim 1, further comprising:
training an individual to be an advisor to a high school student in the college application process;
associating said individual with a high school student;
receiving advisor input from said individual regarding said high school student; and
using said advisor input in a submission to a college associated with said high school student.

7. The method of claim 6, wherein said individual is one of a teacher at said high school student's school and a youth worker at a youth agency.

8. The method of claim 7 further comprising teaching advisors a writing curriculum.

9. The method of claim 8 wherein said writing curriculum comprises training on college application essay writing, recommendation writing, and financial aid form completion.

10. The method of claim 1, further comprising:
assigning a college counselor to said student, wherein said college counselor provides said student guidance regarding steps for said student to take in his senior year.

11. The method of claim 10, further comprising:
assigning a college counselor to said student wherein said college counselor provides said student guidance regarding steps for said student to take in his senior year.

12. The method of claim 11, wherein admission to said workshop is restricted primarily to low-income, academically mid-tier students.

13. The method of claim 12, where the workshop is residential.

14. The method of claim 12, further comprising recommending at least one college to said student.

15. A method for assisting low-income, academically mid-tier high school students with the college application process, comprising the steps of:
compiling a student's grades and standardized test scores;
comparing said grades and standardized test scores with the admissions criteria of a plurality of colleges;
determining at least one college for which said student's grades and standardized lest scores meet said the at least one college's admissions criteria;
sending a preview portfolio on said student to said at least one college.

16. The method of claim 15, wherein said preview portfolio comprises an essay written by said student, said student's high school transcript, said student's completed common application, and an evaluation from a writing coach.

17. The method of claim 16, wherein said preview portfolio further comprises a teacher recommendation.

18. The method of claim 17, wherein said preview portfolio is sent to colleges between August and December of said student's senior year.

19. The method of claim 18, wherein said preview portfolio is sent to colleges in September of said student's senior year.

20. A computer-implemented method for administering a program for high school students in applying for college, wherein the participants in the program comprise students, high schools, colleges, advisors, volunteers, and guidance counselors, comprising:
storing contact information concerning each participant in a database;
accepting input regarding a student's college application from at least one of a writing coach, an advisor, and said student;
generating, based on said input, a preview portfolio in an electronic form acceptable to a college;
submitting said preview portfolio to a college in electronic form.
